(19) United States
(12) Patent Application Publication
(10) Pub. No.: US 2007/0245305 A1
(43) Pub. Date: Oct. 18, 2007

(54) LEARNING CONTENT MENTORING SYSTEM, ELECTRONIC PROGRAM, AND METHOD OF USE

(76) Inventor: Jonathan B. Anderson, Eagan, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/554,359

(22) Filed: Oct. 30, 2006

Related U.S. Application Data
(60) Provisional application No. 60/731,530, filed on Oct. 28, 2005.

(51) Int. Cl. G06F 9/44

(52) U.S. Cl. 717/110

(57) ABSTRACT

A learning content mentoring system for use by a user to master a desired dialog stream includes a computer operable to run an editor program and generate a scenario file including a plurality of scenario segments of the desired dialog, and a player interface configured to electronically communicate with the scenario file. In this regard, the editor program is operable to challenge the user with the scenario segments of the desired dialog, the player interface is operable to transmit a response from the user to the editor program for comparison with an expected response, and the editor program interacts with the player interface based on the user response to train the user to respond with the desired dialog.

### CROSS-REFERENCE TO RELATED APPLICATIONS

This Non-Provisional Utility Patent Application claims the benefit of the filing date of U.S. Provisional Patent Application Ser. No. 60/731,530, filed Oct. 28, 2005, entitled “VIRTUAL MENTORING SYSTEM AND METHOD,” which is incorporated herein by reference.

### BACKGROUND

A wide range of business professionals and others have job functions that require conveying precise information in an accurate manner to clients and customers. These professionals realize that the information they deliver must be consistent (i.e., “on message”) and free of extraneous information that could cloud the particulars that the business professional desires to convey.

For example, sales professionals meeting with customers and/or prospective customers desire to provide information related to the product family that is directly targeted to meeting the customer's needs and solving specific problematic issues. In a similar manner, pharmaceutical representatives interact with doctors who are able to spend only a very limited amount of time with any one pharmaceutical representative. Since most pharmaceutical representatives are not doctors, they must be well versed in the medical jargon to be credible, and must be highly skilled in communicating precise information in the shortest possible time. With these examples as a background, it is apparent that sales professionals, pharmaceutical representatives, college recruiters, politicians, and other business and professional people are motivated to train themselves to convey accurate “on message” information in real life scenarios.

Sales and business professionals have been known to use audio recordings, such as a cassette player, to listen to an example of a person speaking a talking point to be conveyed to a target audience. By repeatedly listening to the audio recording, and attempting to speak along or after listening to the audio recording, it is possible to learn a set of talking points. However, this process is less than ideal. For example, a pharmaceutical representative listening to an audio recording may practice repeating what they have heard in the audio recording, but stumble at a point when they arrive at new medical jargon or specific drug information. In this case, the pharmaceutical representative is left with a feeling of uncertainty during the practice session that can affect their performance in the field. Other learning techniques include reading text, for example from a book, and practicing reciting the text. This rote memorization is tedious, and does little to train the professional to perform at a high level in a sales field situation.

Thus, some known mentoring systems provide voice recording and playback, but lack interactive feedback. For these and other reasons, there is a desire for improved learning systems for busy professionals.

### SUMMARY

One aspect of the present invention provides a learning content mentoring system for use by a user to master a desired dialog. The system includes a computer operable to run an editor program and generate a scenario file including a plurality of scenario segments of the desired dialog, and a player interface configured to electronically communicate with the scenario file. In this regard, the editor program is operable to challenge the user with the scenario segments of the desired dialog, the player interface is operable to transmit a response from the user to the editor program for comparison with an expected response, and the editor program interacts with the player interface based on the user response to train the user to respond with the desired dialog.

Another aspect of the present invention provides a computer-readable medium having computer-executable instructions useful in mentoring a user to learn a desired dialog. The computer-readable medium includes at least one editor program configured to generate a scenario file including a plurality of scenario segments, and a player interface configured to electronically communicate with the scenario file. In this regard, the user inputs data into the player interface in response to one of the plurality of scenario segments, and the editor program interacts with the player interface based on the input data to train the user to respond with the desired dialog.

Yet another aspect of the present invention provides learning content mentoring system useful in mastering a stream of dialog. The system includes computer operated means for generating a file including segments of an expected dialog, electronic means for cuing a user response related to the expected dialog, and means for electronically capturing the user response, comparing the user response to the expected dialog, and interacting with the user based upon the comparison between the user response and the expected dialog.

### BRIEF DESCRIPTION 0F THE DRAWINGS

Embodiments of the invention are better understood with reference to the following drawings. The elements of the drawings are not necessarily to scale relative to each other. Like reference numerals designate corresponding similar parts.

FIG. 1 illustrates a perspective view of a learning content mentoring system according to one embodiment of the present invention.

FIG. 2 illustrates a schematic of an electronic program operable by the learning content mentoring system of FIG. 1 in accordance with the present invention.

FIG. 3 illustrates a schematic of scenario learning units including scenario segments created in a file by the program of FIG. 2 in accordance with the present invention.

FIG. 4 illustrates modes of the learning units of FIG. 3 in accordance with the present invention.

FIG. 5 illustrates a player interface of the system of FIG. 1 according to one embodiment of the present invention.

FIG. 6 illustrates electronic audio tools of the player interface of FIG. 5 according to one embodiment of the present invention.

FIG. 7 illustrates the program of FIG. 2 employed to launch a scenario of the learning content mentoring system.

FIG. 8 illustrates electronic folders maintaining electronic files created by the program of FIG. 2 according to one embodiment of the present invention.

FIG. 9 illustrates an overview screen employed by the program of FIG. 2 according to one embodiment of the present invention.

FIG. 10 illustrates a proving ground mode of the program of FIG. 2 according to one embodiment of the present invention.

FIG. 11 illustrates the player interface of FIG. 5 including talking points and recommended phrases of one or more learning unit segments according of the program.

FIG. 12 illustrates a scorecard of the overview screen of FIG. 9.

FIG. 13 illustrates the player interface operated in an initial practice mode.

FIG. 14 illustrates the player interface operated in an advanced practice mode.

FIG. 15 illustrates the player interface operated in a game mode.

FIG. 16 illustrates the player interface operated in a certification mode.

FIG. 17 illustrates a scorecard of the certification mode according to one embodiment of the present invention.

FIG. 18 illustrates the program in the certification mode including an accept button that enables a user to self-correct the program and automatically receive earned credit.

FIG. 19 illustrates a guide book of the program according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Embodiments of the present invention provide a learning content mentoring system that is a computer-based, virtual coach that guides sales representatives, business professionals, call center representatives, and others to improve performance on the job. The system provides customer contact training and practice on verbal (i.e., oral) communication and software skills in a low-risk environment. The system environment is realistic, but instead of conversing with real customers, learners interact with computer-simulated customers. In addition, instead of interacting with the real software systems of a business, learners work with an emulation of those systems.

The above-referenced system delivers computer-based customer contact training in the form of learning units and enables the learner to practice with the simulated customer while simultaneously using and learning call center software systems. Embodiments of the system provide for a computer, a program operable by the computer, and a voice recognition engine coupled to the computer. In one embodiment, the computer employs audio files to play the part of the customer, and the computer employs voice recognition technology to “listen” for key words in the learner's conversation. In this manner, the system allows the learner to practice and receive feedback in all facets of customer contact, including: call handling techniques, providing account information, providing product/service information, acting on customer requests, accessing, researching, and updating the customer's account, working with the necessary business software in general.

Embodiments of the system also provide recording the learner's spoken interactions with the simulated customer, such that the learner's supervisor can listen to the learner's customer contact performance during a simulated call. Benefits of using the system include a shortened learning curve, and improved call center performance on the job while at the same time reducing the amount of time that a supervisor spends on the call center floor attending to the needs of trainees.

Embodiments of the system include a voice recognition engine employing voice recognition technology to “listen” to the learner's conversation for key words. In this regard, the system is configured to “learn” the user's voice, and after learning the inflection and pronunciation patterns of the user, comparing the spoken words from the user with a targeted list of key words that are desired to be communicated to a customer. Other embodiments of the present invention provide for a mechanism by which learner's can “dispute” the system's failure to correctly “hear” something that the learner has indeed spoken.

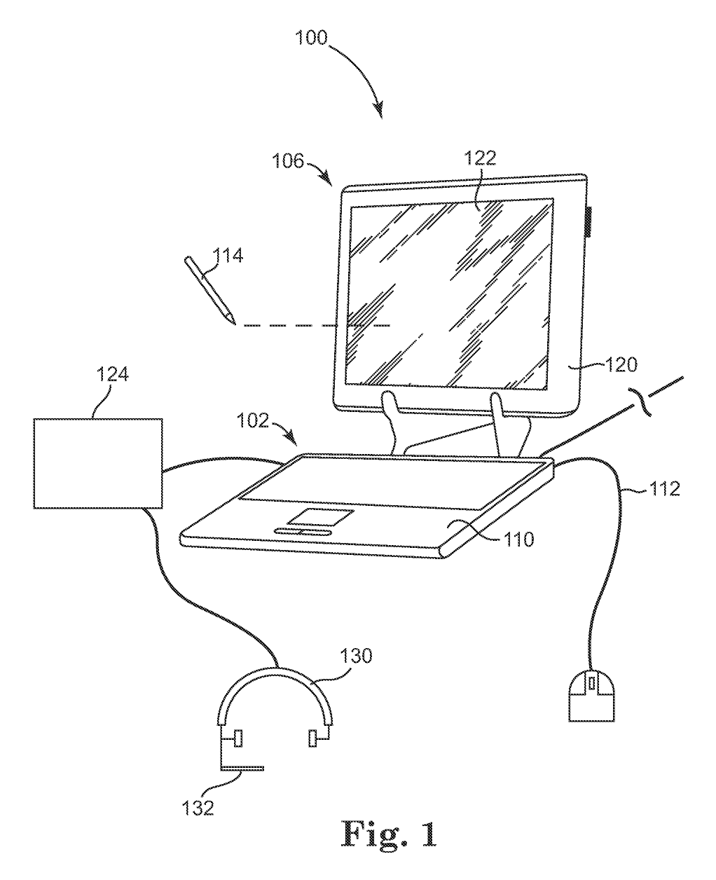

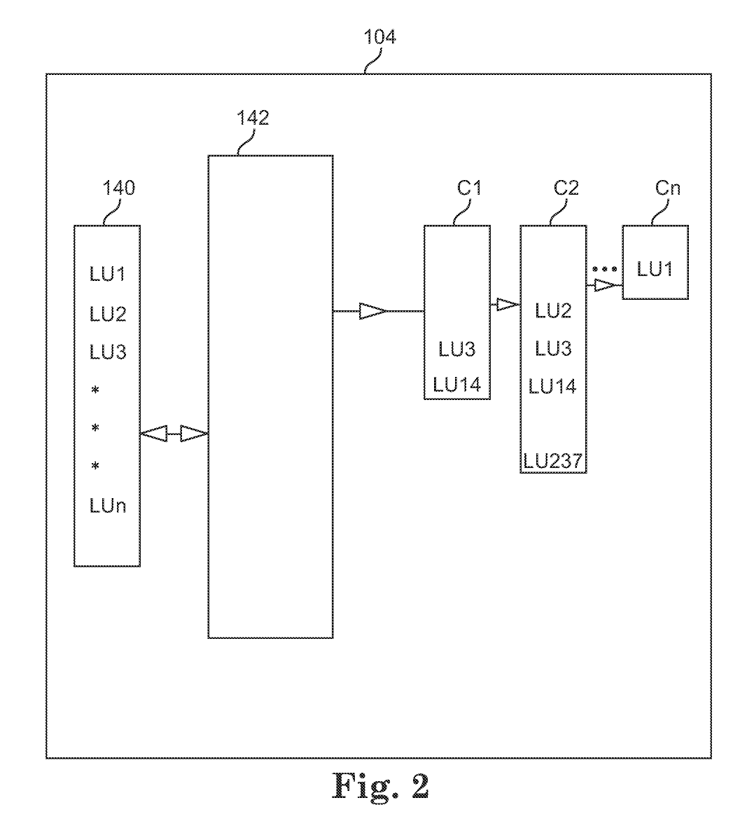

FIG. 1 illustrates a perspective view of a learning content mentoring system 100 according to one embodiment of the present invention. System 100 includes a computer 102 operable to run an editor program 104 (best illustrated in FIG. 2), and a player interface 106 that electrically communicates with scenario files generated by program 104. Editor program 104 generates electronic scenario files composed of scenario segments of a desired stream of dialog, for example. A user running program 104 interacts with the scenario files to master informational content that the user will later employ in communication with customers and/or clients.

In one embodiment, computer 102 includes a housing 110 enclosing a hard drive and memory (not shown), and components that enable a user of program 104 to interact with player interface 106, for example a mouse 112 or a stylus 114. In one embodiment, player interface 106 is coupled to computer 102 and includes a monitor 120 having a screen 122, where player interface 106 electrically is configured to communicate with a voice recognition engine 124 (for example, through computer 102).

In one embodiment, during use a user of system 100 dons a pair of headphones 130 including a microphone 132 and interacts with player interface 106. For example, the user might employ the mouse 112 to highlight a scenario that has been generated by program 104. The user launches the scenario with player interface 106, for example by clicking on a desired scenario with the mouse 112. Once a scenario is launched, the user interacts with player interface 106 (and with program 104) to learn/master a desired dialog stream. In interacting with player interface 106, the user is challenged by program 104 with one or more scenarios. The user role plays when interacting with player interface 106, and is mentored by program 104 to practice meaningful responses in light of each particular scenario, eventually learning and mastering a client-specific dialog stream for communication to a third party (a customer, for example).

Learning content mentoring system 100 includes program 104 that is configured to offer/present a challenge to the user (or presents a role for the user to actively fulfill) on the screen 122, and the user responds, for example, with a spoken response into microphone 132. Voice recognition engine 124 records the spoken response of the user, program 104 audio and electronically records the response, tabulates the response, scores the response, and if necessary, interacts with the user (for example by offering related-content hints) in mentoring the user to respond with the desired dialog stream. In this manner, the user is mentored to learn the specific content of one or multiple scenarios.

In one embodiment, voice recognition engine 124 is configured to receive digital data in the form of spoken words from the user, for example when the user reads from a page of written text. In one embodiment, the user reads a predetermined string of text, and voice recognition engine 124 listens to the reading of the text to “train” voice recognition engine 124 to recognize the user's speech patterns. In one embodiment, after voice recognition engine 124 is familiar with the speech patterns of the user, voice recognition engine 124 thereafter records the spoken words by the user and compares these spoken words with a set of key words that program 104 has stored in a dialog scenario. In one embodiment, voice recognition engine 124 and program 104 are configured to score and acknowledge the user's performance in properly speaking the key words in a proper sequence. In one embodiment, voice recognition engine 124 is a computer that employs ScanSoft Imaging Solutions software available from Nuance Company, Burlington, Mass., although other suitable voice recognition software are also acceptable.

System 100 is an electronic system capable of storing many thousands of scenarios, where each scenario can include multiple segments. By electronically ordering (or randomizing) the multiple segments within scenarios, the system 100 can produce a broad range of learning modules that can be repeatably practiced, or reused, by the user. In one embodiment, program 104 is operable to electronically create files of multiple reusable learning interactions (RLI). In one embodiment, the RLI are composed of interchangeable scenarios that can be mixed and matched to develop multiple useful but slightly different curriculums. In this manner, system 100 provides a learning content mentor that interacts with the user across a variety of modes to train and teach the user to respond to stimulus with an appropriate verbal response (or physical response), such as a desired dialog stream or key talking points that are to be covered in a client interaction.

FIG. 2 illustrates a schematic of program 104 according to one embodiment of the present invention. In one embodiment, program 104 is an editor program that generates scenario files and is operable in a computer-readable medium having computer-executable instructions. In an alternative embodiment, program 104 is operable on the worldwide web in Hyper Text Markup Language (HTML). In another embodiment, program 104 is configured to generate scenario files in extensible markup language (XML). In any regard, program 104 is operable by computer 102 to generate and access scenario files, and to present to the user scenario segments of a desired dialog stream.

Program 104 generates scenario files identified as learning units (LU). For example, in one embodiment program 104 generates scenario files including learning units LU1, LU2, LU3, . . . LUn that are electrically accessed by a creation tool 142 within program 104 to compile the learning units LU into a plurality of training sessions, or curriculum such as C1, C2, . . . Cn. For example, in one embodiment program 104 is operable to generate LU files 140, and create a first curriculum C1 with creation tool 142. In this regard, curriculum C1 includes LU3 and LU14. In another embodiment, program 104 generates a different curriculum C2 that includes LU2, LU3, LU14, and LU237. In this manner, program 104 generates multiple LU files 140 that can be mixed-and-matched in a building-block fashion by creation tool 142 to form reusable learning interactions RLI that include multiple curriculums C1-Cn.

In one embodiment, creation tool 142 is configured to enable the user to program, or create, a custom-built curriculum. The user selects elements from among LU1-LUn, employs an electronic editor or other computer-based program to “copy” the selected LU, and fabricates the custom-built curriculum. For example, in one embodiment the user captures screen shots or other video images, keywords or other dialog streams, and builds a custom structured curriculum, or emulation, that is saved by program 104 for repeatable use.

In one embodiment, program 104 is a scenario editor that is a data base driven administrative application programmed in XML language and enables a user to develop a scenario, build scripts, and program simulated software functions to create a customized learning curriculum. For example, in one embodiment program 104 is a scenario editor that provides a user (or a scenario developer) with the tools to build and/or access training in three formats: learning units, customer contact practice, and practice using call center software systems.

Learning units are described in detail below and can include learning units related to customer contact policies, procedures, best practices, business philosophies, and the wisdom behind them. In this regard, learning units can include policy related units, etiquette learning units, handling difficult caller units, and product service descriptions encountered by the user in their job function.

In one embodiment, program 104 includes system emulation screens that are configured to approximate the functionality of real world environments. System emulation screens enable learners to practice using software employed in their job function without the risk of affecting real world data actually affected by interacting with the real software.

In one embodiment, program 104 is a scenario editor that includes a main screen displayed to monitor screen 122 (FIG. 1) that includes an administrative area and a dialog segment area. In one embodiment, the administrative area includes a field that enables a user to set a scenario by identifying the scenario title, number, and brief description. In one embodiment, dialog segment area includes fields for customer-contact elements of the scenario, script, dialog steps, dialog hints, key words, and audio for each dialog segment. In one embodiment, program 104 includes an edit function that enables editing of scenarios by adjusting elements within the learning unit.

In one embodiment, program 104 provides a learning unit editor having a plurality of electronically displayed tabs. In one embodiment, program 104 includes a criteria tab that enables the user to document, explain, and program a range of examples that illustrate the criteria on which the goal of the scenario related to the user's performance is measured. In one embodiment, program 104 includes a Learn It tab that enables the user to program customer contact examples that illustrate a call center's performance in the context of the learning unit topic. In one embodiment, program 104 includes a Try It tab that is configured to enable the user to develop customer contact examples that the learner will evaluate based on relevant performance criteria. In one embodiment, learning unit editor of program 104 includes a Do It tab that is configured to enable the user to develop customer contact examples to which the learner responds to as a call center rep.

Embodiments of program 104 employed as a learning unit editor include digitally programmed function buttons that are accessed by computer 102 through player interface 106. In one embodiment, programmable buttons of the editor include record buttons, stop button, play button, browse button, delete button, and an update button. These buttons may be enabled through the player interface 106 for a user to program segments of a learning unit useful in a custom programmed curriculum.

Embodiments of program 104 employed as a learning unit editor include programming a separate file to be run as a learning unit scenario that includes text that guides the user in completing the scenario; an audio transcript that can be played by the user to listen to an example of a customer interaction; a record and playback function that is operated by program 104 to electronically capture a performance by the user that is critiqued and scored by the program in a manner that provides feedback for the user; and one or more media files that can include audio, video, or other digital files assessable by the user in role playing a scenario.

With regard to program 104, components of the present invention can be implemented in hardware via a microprocessor, programmable logic, or state machine, in firmware or in software with a given device. In one aspect, at least a portion of program 104 is software that is web-based and written in Hyper Text Mark-up Language (HTML) and/or Java programming languages, including links to user interfaces for data collection, such as a Windows® based operating system. Each of the components is operable to communicate via a network using a communication bus protocol. For example, the present invention may use a Transmission Control Protocol/Internet Protocol (TCP/IP) suite for data transport. In another aspect, at least a portion of program 104 is operable to generate a file in Extensible Mark-up Language (XML), including links to a Windows® based operating system, for example. Other programming languages and communication bus protocols suitable for use with the present invention will become apparent to those skilled in the art after reading this disclosure. Components of the present invention may reside in software on one or more computer-readable mediums. The term “computer-readable medium” as used herein is defined to include any kind of memory, whether volatile or non-volatile such as floppy disk, hard disk, CD-ROMs, flash memory, read-only memory (ROM) and random access memory (RAM). In one embodiment, components of the present invention operate on a Microsoft® .NET framework.

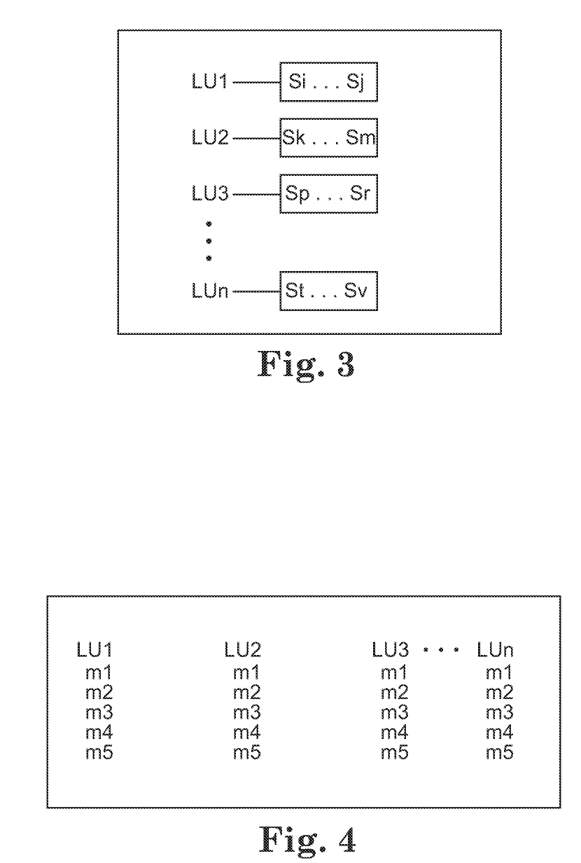

FIG. 3 illustrates a schematic of learning unit LU composition according to one embodiment of the present invention. Each LU includes multiple segments, and each segment can include multiple talking points. For example, in one embodiment learning unit LU1 includes segments Si . . . Sj; LU2 includes Sk . . . Sm; LU3 includes Sp . . . Sr; and learning unit LUn includes St . . . Sv, where each of the segments Si . . . Sv include a bit of information that the user is to master.

In one embodiment, each LU scenario includes multiple exchanges with a customer that the user has a desire to master, and preferably the exchanges have a desired order. For example, each scenario could include four to six spoken sentences between the user and customer, which might entail two to three minutes of dialog or conversation. Each of these exchanges within the scenario is represented by a segment, such as Si . . . Sj. In this regard, each segment can include multiple talking points. A talking point is a bit of information that the user is supposed to convey to the target audience.

In an exemplary embodiment, the user is a pharmaceutical sales representative whose job function is to communicate precise, accurate, and detailed information to a doctor (or other healthcare provider). In this example, the LU scenario includes the topical information that the sales representative intends to convey to doctor. In this conversation, the LU scenario could include three minutes of dialog including segments having to a dozen talking points. Program 104 is operable by system 100 to mentor the user through such an interaction and enable the user to accurately and reproducibly recall and perform the talking points within each segment of the learning unit.

FIG. 4 illustrates that each LU scenario includes five learning modes. In one embodiment, mode m1 is a warm up mode, mode m2 is an initial practice mode, mode m3 is an advanced practice mode, mode m4 is a game mode, and mode m5 is a certification mode.

In warm up mode m1, player interface 106 visually shows the user talking points within segments S of a learning unit LU. In one embodiment, player interface 106 visually shows on screen 122 an action item for the user to perform. In other modes, the user is prompted, taught, or otherwise mentored to act out the action item.

In this regard, the talking points within each segment S include tactics that represent the desired best strategy for handling a given situation or customer interaction. Mastering the talking points is the goal of the user during each LU scenario.

In at least some modes m1-m5, player interface 106 provides recommended phrases on screen 122 as an example of how to perform and complete a talking within segment S. As a user performs a talking point, a status indicator is shown on screen 122 to indicate whether a talking point has been completed. Player interface 106 is configured to construct RLI in a manner that mentors the user to address each talking point, and preferably address each talking point in an ordered and systematic approach.

In warm up mode m1, after the user performs all talking points correctly, the user is prompted by player interface 106 to click a submit the button. Player interface 102 will thereafter respond with audio feedback that advances the LU scenario to the next segment S. In one embodiment, program 104 is configured to not accept an incorrect submission of a talking point. In this regard, if a user incorrectly performs a talking point, program 104 will not enable the submit button to function, as more fully described below.

When in initial practice mode m2, player interface 106 offers a visual representation of all talking points and action items of a segment S in a LU scenario. Initial practice mode m2 varies from warm up mode m1 in that the recommended phrase offered in the warm up mode m1 is now hidden from view. For example, in one embodiment, initial practice mode m2 represents a desired dialog talking point in the form of a verb: object cue. During initial practice mode m2, the user attempts to recall the recommended phrase by viewing the verb: object cue displayed on screen 122 of player interface 106. User verbalizes a response into microphone 132 (FIG. 1), and player interface 106 responds with a green check mark if the talking point is been performed correctly.

Advanced practice mode m3 offers a visual representation of the number of talking points and action items that exist in a segment S of a LU scenario. As the user progresses through modes m1-m5, by the time the user arrives at advanced practice mode m3, some or all of the talking points in segment S have been mastered. Through this form of repetition, RLI provided by program 104 and system 100 mentor the user to achieve mastery of each segment S of each LU scenario. To this end, in the advanced practice mode m3, a user who has mastered the talking points now has the opportunity to begin using more conversational tones and words, while incorporating the recommended phrases learned from mode m1 and m2.

Game mode m4 is characterized in that visual and other cues offered on player interface 106 have been removed. A user of game mode m4 is expected to employ each talking point in a best practice mode for each segment S, and is expected to have mastered the LU scenario to the point where talking points may be performed in any order as long as each is covered by the user during the dialog. Player interface 106 electrically communicates with voice recognition engine 124 to record a performance record, and indicates through visible check marks (for example, a green check mark for a correct answer, or a red check mark for a talking point that has been missed) on screen 122 information related to the user's progress.

Certification mode m5 is a self evaluation mode that enables the user to amend, or adjust a score, of their performance. Certification mode m5 enables the user to “override” the computer 102 interpretation of their performance.

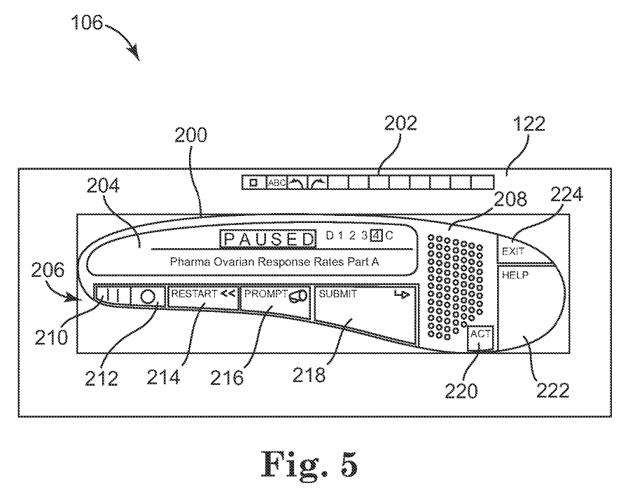

FIG. 5 illustrates screen 122 of player interface 106 according to one embodiment of the present invention. Screen 122 includes an electronic representation of a virtual player 200 and a floating toolbar 202. Player 200 includes a text field 204, a plurality of buttons 206, and a representation of an audio feedback field 208.

Floating toolbar 202 enables real-time access by the user to various other programs of computer 102, including, for example, access to the worldwide web, search engines, or other software.

Text field 204 provides information related to one or more of segments S, and/or other information provided by program 104. In general, the plurality of buttons 206 is clickable, for example via mouse 112 (FIG. 1). In this regard, the user interacts with buttons 206 to initiate and/or repeat a stream of audio data received through headphones 130 (FIG. 1), or to submit a response for evaluation.

Buttons 206 include a pause button 210, a listen button 212, a restart button 214, a prompt button 216, a submit button 218, an act button 220, a help button 222, and an exit button 224.

Pause button 210 is available in each mode m1-m5 within program 104. Pressing pause button 210 causes player 200 to stop voice recognition engine 124 from voice recording. In one embodiment, player 200 is configured to automatically deactivate pause button 210 for segments S that include action items to be performed by the user instead of talking points to be spoken by the user. In one embodiment, player 200 is configured to automatically set its status to “pause” after five minutes of inattention.

Listen button 212 is activated at the beginning of each LU scenario as operated by program 104. In one embodiment, listen button 212 is automatically activated by program 200. In another embodiment, program 104 is configured to prompt the user to begin a learning unit LU through the generation of a tone. Listen button 212 is configured to enable player 200 to record audio through microphone 132 in headset 130 (FIG. 1). In one embodiment, a red light is provided on floating toolbar 202 to inform the user of the “on” recording status. In one embodiment, player 200 is configured to automatically deactivate listen button 212 for segments S that include action items rather than talking points to be spoken by the user.

Restart button 214 is operable in modes m1-mode m4. In one embodiment, player 200 disables restart button 214 in certification mode m5. In one embodiment, system 100 is configured such that clicking restart button 214 one time recalibrates program 104 for a moment and then begins a current segment S at its beginning. Clicking restart button 214 a second time while it is recalibrating sets the player 200 status to the previous segment S. Emulations, described below, may also be restarted by pressing restart button 214. Restart button 214 enables repetitive practice by the user of recommended talking points or phrases.

Prompt button 216 is provided to generate a hint when the user meets with difficulty in verbalizing a talking point. In one embodiment, player 200 is configured to prompt the user with a talking point based upon data received by program 104 from microphone 132. In general, pressing prompt button 216 causes player 200 to pause voice recognition engine 124. Thereafter, the user is able to resume performance in a LU scenario by clicking prompt button 216 a second time.

In one embodiment, player 200 is configured to deactivate prompt button 216 for segments S of LU scenarios in which action items are employed instead of talking points. In general, prompt button 216 is enabled in modes m2, m3, and m4. In warm up mode m1, pressing prompt button 216 merely pauses voice recording by player 200. In initial practice mode m2, pressing prompt button 216 results in a recommended statement being projected on screen 122. Continued pressing of prompt button 216 in mode m2 will pause voice recording by player 200.

In advanced practice mode m3 and game mode m4, pressing prompt button 216 results in the display of a talking point or action on screen 122, but does not result in a display of a recommended statement. Player 200 disables prompt button 216 when in certification mode m5.

Submit button 218 is configured to register an evaluation of a vocal response by the user through player 200 relative to the current segment S. Depending upon the modes m1-m5 and the number of hints requested by a user, pressing submit button 218 either advances the user to the next segment S, or initiates an intervention by a coach window visible on screen 122. For example, pressing prompt button 216 twice during any one segment S will result in the coach window informing the user of a recommendation to practice that particular LU scenario again before moving on to the next segment S in the learning unit.

In one embodiment, player 200 deactivates the submit button 218 for all segments S that include an action item instead of a verbal talking point. In one embodiment, player 200 is configured to immediately and automatically activate submit button 218 when the user completes all action items of a segment. In one embodiment, player 200 will not activate the submit button 218 in warm up mode m1, initial mode m2, or advance practice mode m3 until all talking points or action items are completed for the current segment S. In game mode m4 and certification mode m5, submit button 218 is active as soon as the user begins each scenario of a learning unit LU. In this regard, if the user clicks the submit button 218 when in the game mode 4 and has not performed every talking point or action item of the segment S correctly, the player 200 will respond with an electronic stream of customer feedback. The stream of customer feedback includes either an audio clip or a video clip electronically provided by program 104 on screen 122 to offer the user a hint or an example related to the missed talking point or action item.

In this regard, the user may obtain hints in all modes except game mode m4. In the other modes, if the user requests a hint in a segment S, and then clicks submit button 218, the coach window pops up on screen 122 and offers the option to the user to repeat the same segment S or move on to the next segment. If the user requests and receives two or more hints in a segment S, pressing the submit button 218 results in the coach window directing the user to repeat the same segment S before advancing to the next segment in a learning unit LU. In this manner, system 100 strives to encourage the user to master each segment S.

In one embodiment, pressing submit button 218 in certification mode m5 will end a segment immediately and trigger program 104 to record and calculate a performance record related to the evaluation of that LU scenario. In this regard, if there is a subsequent segment in the learning unit, pressing submit button 218 activates that subsequent segment for performance by the user. If there are no more segments in the learning unit LU, pressing the submit button 218 closes player 200 and generates an evaluation of a performance record for that learning unit. In one embodiment, the performance record is configured for email transmission from computer 102 across a network that computer 102 is coupled to.

Act button 220 is active only when a LU scenario necessitates that the user take an action. For example, the user clicks act button 220 if the learning unit necessitates that the user indicate that they are at a specific page of a training manual, a marketing piece, or a clinical study. In one embodiment, the functions of act button 220 are constant between modes m1-m5.

Exit button 224 closes player 200 and is available in modes m1-m5. Pressing exit button 224 will prompt a dialog box to pop up on screen 122 to query whether the user desires to exit the LU scenario. If the user had the intention to exit the learning unit, clicking the exit button 224 will complete the exit from player 200. In one embodiment, in modes m1-m4 an intermediate exit is enabled by restart button 214. Pressing restart button 214 will trigger program 104 to move back to the beginning of a segment S in a LU scenario. In one embodiment, clicking exit button 224 in certification mode m5 will default program 104 to the beginning of that particular scenario segment S.

Help button 222 is electrically coupled to a plurality of functions in program 104 including back, time-out, and audio tools available in modes m1-m4. Help button 222 is disabled in certification mode m5. In one embodiment, pressing or clicking help button 222 will display a window or popup dialog box on screen 122 and generate advice directed to one or more talking points. In this regard, the back button function within help button 222 closes the help window. The time-out button within help button 222 will reveal all recommended phrases and talking points and action items, as well as provide access to an audio tool. Audio tool is accessed by clicking help button 222 and then a clicking time-out button. In this regard, audio tools in help button 222 enables a user to practice pronunciation of a phrase or listen to an expert pronounce a particular word or phrase, as more fully described below.

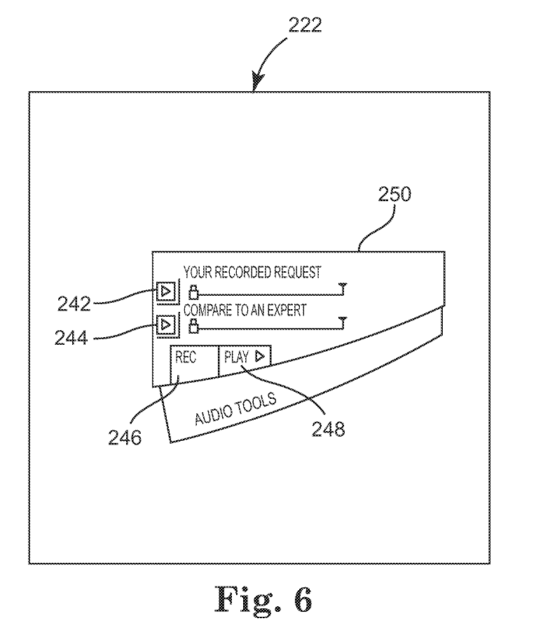

FIG. 6 illustrates electronic audio tool functions of help button 222 according to one embodiment of the present invention. Audio tool components of help button 222 includes a first playback button 242, a second playback button 244, a record button 246, a play button 248, and sliding levers 250.

First playback button 242 provides a “your recorded request” play button. Clicking first playback button 242 plays the recording of the user's voice in the most current talking point. In other words, clicking first playback button 242 plays a recording of the user's last attempt at speaking/verbalizing the last talking point prior to having clicked the help button 222.

Second playback button 244 is a “compare to an expert” play button. Clicking second playback button 244 plays an audio example of a suggested “expert” example of the talking point in the segment S of the LU scenario in which the user is currently working. This “expert” example can be played as many times as requested by the user. The audio example of the expert pronunciation of the talking point cannot be erased, changed or recorded over.

During playback, slide levers 250 are operable to stop the recording of “your recorded request” or “compare to an expert” at any time and may be moved to any specific point during that audio clip. Each of the slide levers 250 are provided with an audio margin bracket configured to isolate portions of the talking point segment during audio review by the user.

The record button 246 enables audio recording of the user's voice. Pressing record button 246 and speaking into microphone 132 generates a recording of the user's voice that can be compared to “your recorded request” and “compare to an expert” recordings. By pressing the record button 246, the user can record and re-record their voice as many times as desired. Each subsequent recording erases the previous recording. In any regard, pressing the record button 246 does not change, erase, or record over the “your recorded request” or “compared to an expert” audio samples.

Play button 248 plays one or more recordings created when the record button 246 was pressed. In a similar manner, pressing the play button 248 will not play, record over, change, or erase the “your recorded request” or “compare to an expert” audio samples. In one embodiment, audio tools include a demo button which is configured to appear if the LU scenario includes an action item for the user to complete.

Embodiments of program 104 enable the user to interact electronically with player window 204. For example, in modes m1-m4 talking points that are verbalized by the user are received by system 100 through the microphone 132, and player window 204 is illuminated with indicia to indicate that system 100 has received input from the user. In one embodiment, the indicia is a white halo that flashes or otherwise provides a visual cue to the user that the dialog has been received by system 100. In another embodiment, player interface 106 is configured to interact with the user through a sound card (not shown) of computer 102 (FIG. 1). In the case where the user verbalizes a word that is not a talking point or a segment S of a LU scenario, the player window 204 does not respond with indicia.

In one embodiment, player window 204 is configured to respond to the user with a series of check marks to indicate progress of the user in modes m1, m2, and m3 (warm up mode, initial mode, and advance practice mode, respectively). For example, as the user completes a segment S by properly pronouncing a talking point, a checkmark appears in the player window 204. These informational indicia flash and the user hears a chime, for example, to indicate that a talking point has been completed.

In one embodiment, player interface 106 is configured to provide progress data to the user. For example, in game mode m4, after the user clicks the submit button 218, player window 204 provides text showing the talking points that the user has been credited for, and talking points that have not yet been completed. In this regard, player window 204 is configured to provide evaluation symbols such as a green checkmark for credited talking points, and a red X for talking points that have not been completed, although other marks are also acceptable.

In one embodiment, player window 204 interacts in real-time with the user. For example, after the user clicks the submit button 218, player window 204 will indicate a red X for a talking point that is not been verbalized. Should the user thereafter properly pronounce the talking point, program 104 changes the red X (for incomplete) to a green checkmark (for completed) in player window 204. In another embodiment, the user may click the prompt button 216 to receive a hint relative to the talking point from player window 204. In one embodiment, where the user fails to correctly verbalize a talking point after three attempts, player window 204 directs the user to restart that segment S, thereby establishing a mentor pathway that demands consistently high user performance, which drives user mastery of each LU scenario.

In this specification, talking points are defined to be information strings and/or bits of information that a user of system 100 is to master in preparation for interactions with a target audience. For example, a talking point can be a tactic or a word that represents a company's strategy for informing a client or customer of a given product, or a best practice for handling a given situation. In one embodiment, player window 204 provides a recommended phrase that is an example of how to perform and complete the talking point. As the user progresses through modes m1-m5, player window 204 provides fewer visual prompts to assist the user in properly pronouncing the talking point.

In some embodiments, a “why statement” is provided by player window 204 to explain the rationale of the associated talking point or action item. Not all talking points have a why statement.

An action item is a physical act that the user should understand and master in the context of the appropriate talking point. For example, a talking point may be related to an introductory portion of a pharmaceutical brochure, and an action item related to that talking point may be the user mastering the timing of recommending that the customer turn to a certain page of that brochure.

A status box is provided as a square icon in the player window 204 and is associated with each talking point or action item. The status box indicates how the player interface 106 is evaluating the user's progress and includes interactive symbols to give the user this information in real time.

In one embodiment, program 104 is configured to enable player interface 106 to provide hint symbols. In one embodiment, the hint symbol is a letter h that registers the user's request for a hint after the user presses prompt button 216. If the user subsequently performs that talking point or action item correctly, the h is transformed into a green H by program 104. A green H hint symbol indicates that the hint has been used to correctly answer or verbalize a talking point.

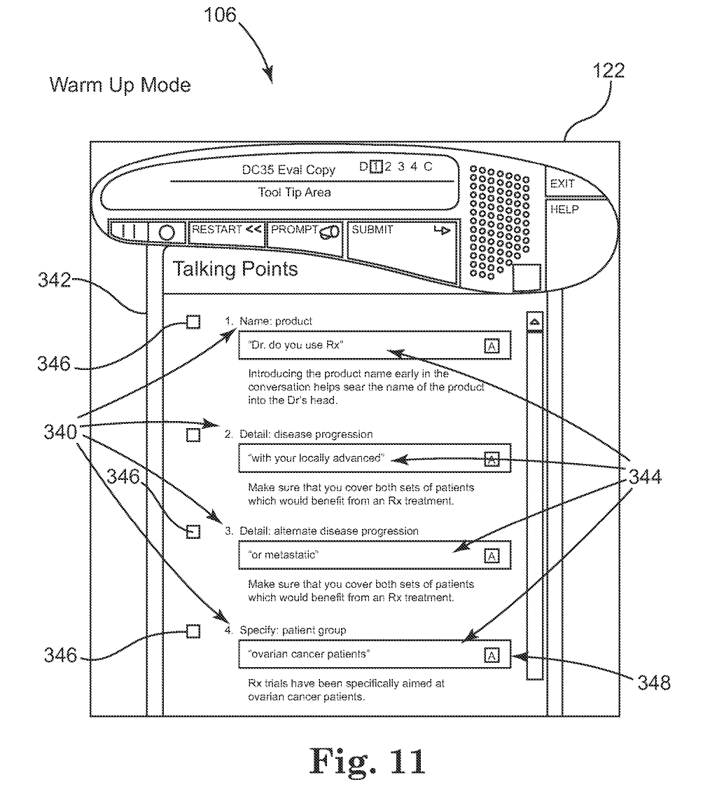

An accept icon is provided and indicated by A (See FIG. 11). In one embodiment, program 104 is configured to provide the accept icon to correct voice recognition errors attributed to voice recognition engine 124. If the user suspects that a voice recognition error has occurred, player interface 106 will credit the user for a talking point if the user challenges the player interface 106 by clicking on the accept icon (A).

A green checkmark symbol provided by player interface 106 in player window 204 will appear inside the status box of player window 204 once a talking point has been completed successfully.

A slash symbol is an icon visible on player window 204 as a diagonal line. When a user verbalizes a talking point, but not in the recommended order, the slash symbol will appear inside an empty status box for about a second and thereafter disappear. The slash symbol is utilized in warm up mode m1, initial practice mode m2, and advanced practice mode m3.

Player interface 106 is configured to provide a red underline under a green checkmark icon in player window 204 to indicate that the user has performed the corresponding action item correctly.

As described above, and with reference to FIGS. 1-3, system 100 provides an interactive electronic database of reusable learning interactions (RLI) that are electronically accessed by the user in learning and mastering a dialog stream useful in performing the user's job function, especially in the case where the user is required to communicate a specific accurate data set of knowledge to a client skilled in that data set. Program 104 enables the user to craft a variety of training programs, or curriculum Cn, by assembling LU scenarios 140 into a selected and desired training regimen.

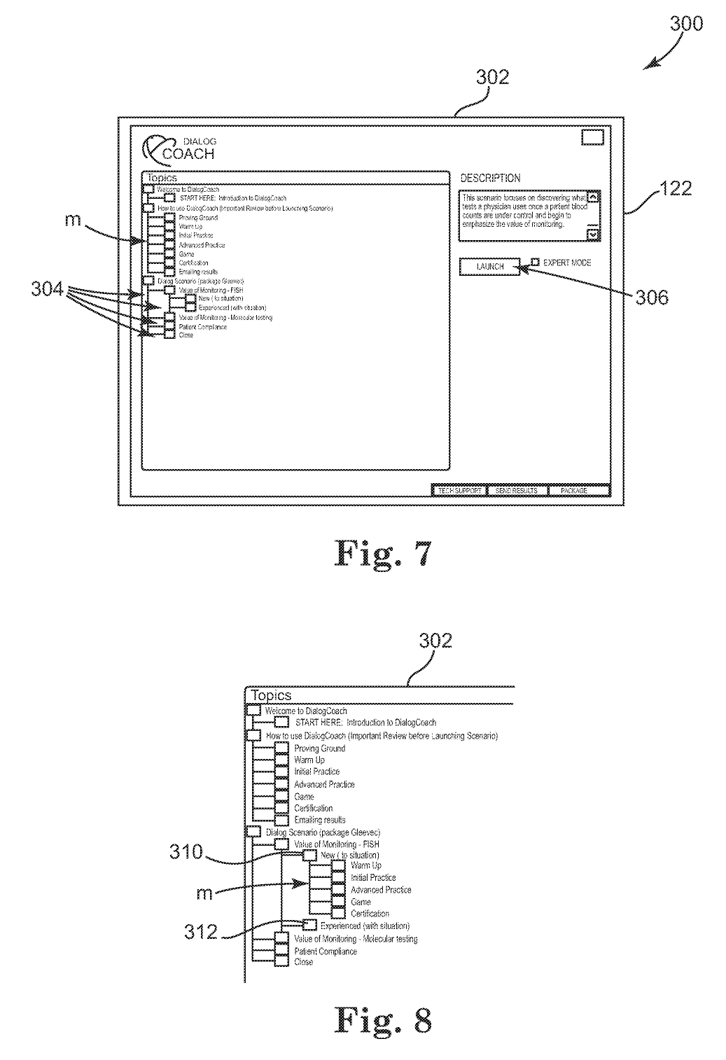

In an exemplary embodiment, the user may have an interest in curriculum C2 which provides learning units LU2, LU3, LU14, and LU237. In this regard, although the user may not have an immediate interest in curriculum C1, C1 is nevertheless available since electronic program 104 has sufficient memory to store many hundreds of curriculum Cn. To this end, learning units 140 can be coupled together by the user to craft a targeted curriculum Cn that is useful in mentoring the user to master a conversational dialog stream. A specific example of employing system 100 as a dialog coach as a learning content mentoring system is provided below in FIGS. 7-19 with reference to FIGS. 1-2.

FIG. 7 illustrates a launch sequence 300 of a scenario on screen 122. Launch sequence 300 includes a popup window 302 on screen 122. Popup window 302 includes fields for selecting a mode m, a scenario list 304, and a launch button 306. In this regard, the scenario list 304 is analogous to a curriculum C1 . . . Cn that is composed of LU building blocks 140 of program 104. Each of the options in scenario list 304 is a separate curriculum composed of separate learning unit building blocks. The user selects a desired scenario by highlighting with mouse 112 on screen 122 and clicking launch button 306.

FIG. 8 illustrates an enlarged section view of popup window 302 according to one embodiment of the present invention. Popup window 302 provides user activated icons 310, 312. Icon 310 is clicked if a user is new to the situation/scenario. Icon 312 is clicked if the user is experienced with the situation/scenario. Clicking on icon 310 for a new user will begin a practice session in warm up mode m1.

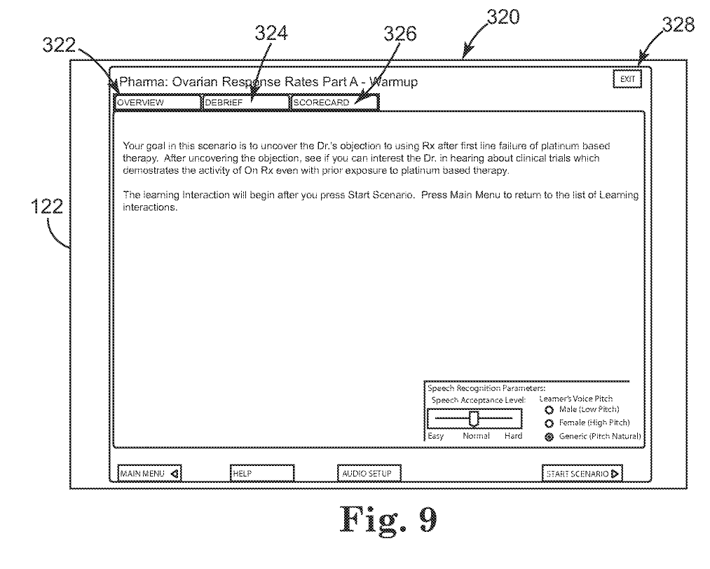

FIG. 9 illustrates program 104 operated by system 100 to provide an overview screen 320 on monitor screen 122. Overview screen 320 pops up on monitor screen 122 after the user launches a scenario by launch sequence 300 (FIG. 7). In one embodiment, overview screen 320 includes three clickable tabs: an overview tab 322, a debrief tab 324, and a score card tab 326.

Overview tab 322 provides background information on the goals and direction of the LU scenario 140 of curriculum C1. Debrief tab 324 provides the user's score upon completion of the LU scenario. Score card tab 326 provides access to all practice sessions of the user in each level of system 100. In one embodiment, the user exits program 104 by clicking on exit button 328.

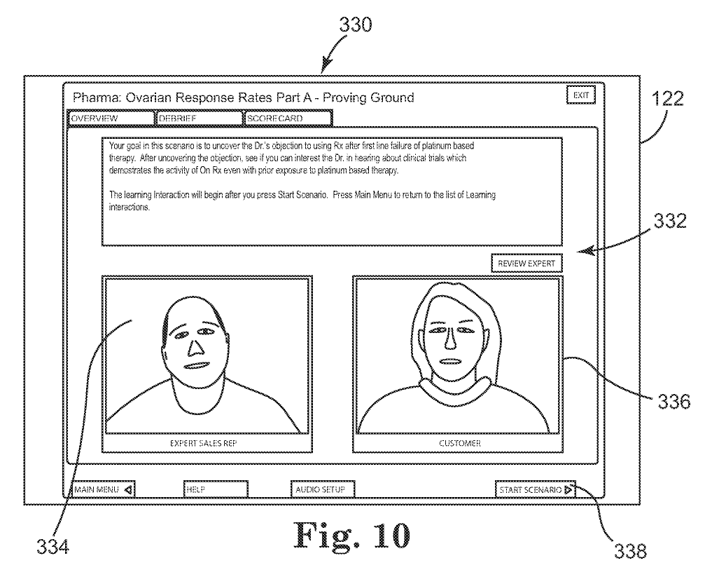

FIG. 10 illustrates an interactive proving ground dialog box 330 provided on monitor screen 122 according to one embodiment of the present invention. Many experienced sales professionals believe that they can manage any obstacle presented to them by the customer and feel confident that they are conveying the marketing message and desired dialog stream on every sales call. Proving ground dialog box 330 provides an interactive mentoring system to hone these skills.

First, proving ground dialog box 330 provides a “review expert” button 332. Clicking the review expert button 332 plays a video tape of a conversation between a sales professional 334 and a customer 336 that provides an idealized example of a desired interaction between sales people and the customer. Clicking start scenario button 338 begins a learning unit 140 within the proving ground 330 that has the user taking on the role of the sales professional. The user is able to review the strategy, or the strategic goals, for the set of statements by viewing the description box provided in the proving ground dialog box 330. After practicing with the proving ground 330, the user clicks the submit button 218 (FIG. 5) for scoring of their performance.

FIG. 11 illustrates player interface 106 visible on screen 122 in warm up mode m1 according to one embodiment of the present invention. Talking points 340 are visible in popup box 342. Again, talking points 340 include the desired information stream to be mastered by the user. Recommended phrases 344 are provided as examples on how to perform and complete in a correct manner talking points 340. Status indicators 346 are provided that indicate to the user whether a talking point 340 has been covered during interaction with the player interface 106. Accept button 348 is provided relative to each recommended phrase 344. In warm up mode m1, after the user performs all talking points correctly, clicking the submit button 218 (FIG. 5) will advance the user to the next segment. If the user is certain that they said a talking point correctly but didn's receive a check mark in the status box 346, clicking accept button 348 will flag the talking point 340 as having been completed. In this manner, the user is able to override inaccuracies that are potentially created by voice recognition engine 124.

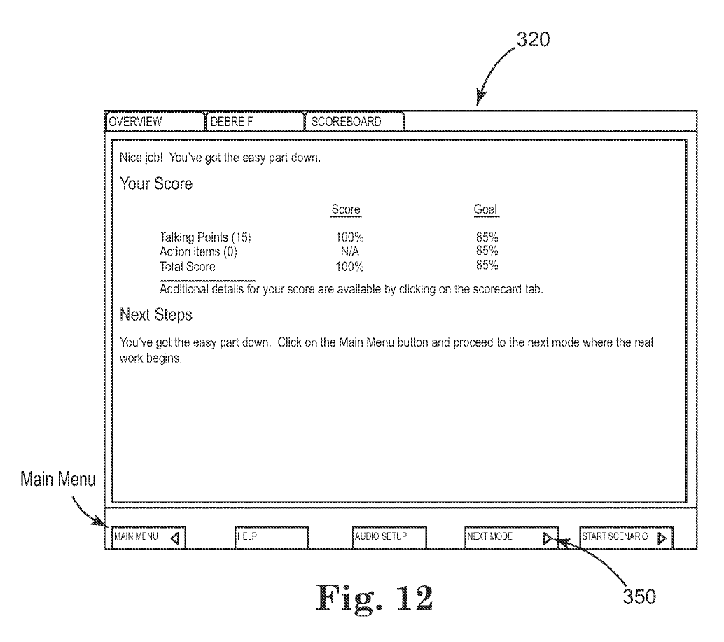

FIG. 12 illustrates another embodiment of overview screen 320. When the user exits from any one learning mode m1-m5, a next mode button 350 appears on overview screen 320. Next mode 350 button enables a user to navigate from one learning mode (for example m1) to another learning mode, such as m2.

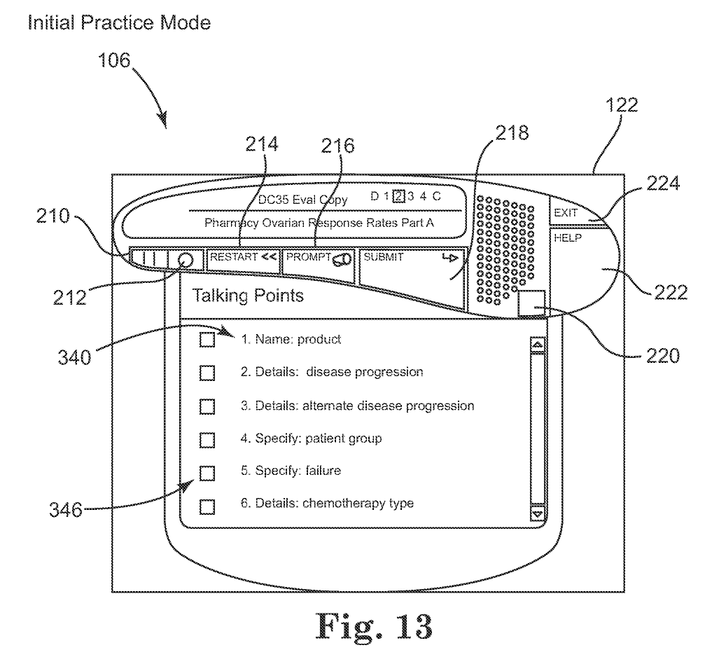

FIG. 13 illustrates player interface 106 in initial practice mode m2. In initial practice mode m2, player interface 106 displays all talking points 340 and action items, but the recommended phrase 344 (FIG. 11) is not displayed. Should the user be unable to recall the recommended phrase 344, clicking prompt button 216 will display the phrase for instantaneous but temporary review by the user. Clicking the prompt button 216 a second time will return the user to active interaction with player interface 106. A blue letter h will appear in status box 346 to indicate that the user has taken a hint. In one embodiment, program 104 tracks how many hints the user employs, and thus monitors the user's progress in any one learning unit LU. If the talking point 340 is performed correctly, the lower case h will turn to a capital letter H (colored green) to indicate that the user is to proceed to the next talking point.

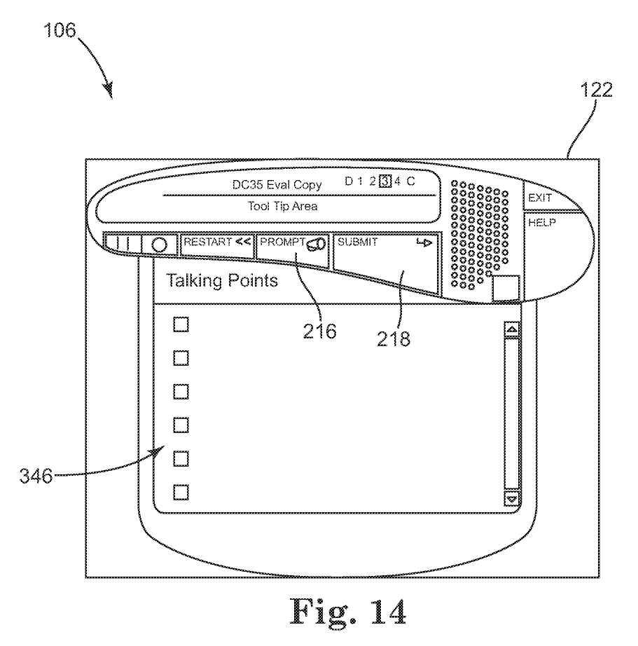

FIG. 14 illustrates player interface 106 operated by the user in the advanced practice mode m3 according to one embodiment of the present invention. In advanced practice mode m3, player interface 106 and screen 122 display the number of talking points, but not the text of the talking points or action items. In this regard, in advanced practice mode m3 the user has progressed through interaction with the reusable learning interactions of the player interface 106 to the point where the user has mastered the displayed talking points that appear in FIGS. 11-13. The display of the number of talking points 346 (but not their text) cues the user to recall the talking points in their proper sequence, which is desired in achieving mastery of the dialog stream. If the user is unable to recall the talking point, the user may click on the prompt button 218 for assistance, as described above. Player interface 106 interacts with the user to mentor mastering of the talking points by requiring that each sequential talking point be completed before moving onto the next talking point. Again, the blue lower case h appears in the status box to indicate that a user has taken a hint. Once a talking point is performed correctly, the lower case h turns to a green capital H to indicate that the user should proceed to the next talking point.

When a user progresses through the LU scenario by performing all talking points and/or action items correctly, the user clicks on the submit button 218 and player interface 106 responds with an audio clip or video clip providing feedback that advances the learning unit LU to the next segment S. A failure to perform all talking points correctly will disable performance of the submit button 218. In one embodiment, the user becomes adept at interacting player interface 106. In this regard, overview screen 320 (FIG. 9) provides access to an expert mode located next to the launch button 306 in FIG. 7. Expert mode is configured to skip some of the audio instruction that is contained in each scenario.

FIG. 15 illustrates player interface 106 operated in game mode m4 according to one embodiment of the present invention. In game mode m4, all support, such as talking points 340 (FIG. 13) and recommended phrases 344 (FIG. 11) have been removed from display. In game mode m4, the user is encouraged to use their own words to convey the best practices for each segment of each learning unit LU, and there is no requirement to perform the talking points in order. Once again, correctly performing the talking points results in the user receiving credit as described above. The prompt button 218 is active in game mode m4 for accessing hints. However, talking points are not revealed without registering a hint symbol in the corresponding status box. Should the user perform a talking point incorrectly, or leave one or more talking points incomplete, upon clicking the submit button 218 the player interface 106 responds with audio feedback to provide a hint of what has been overlooked.

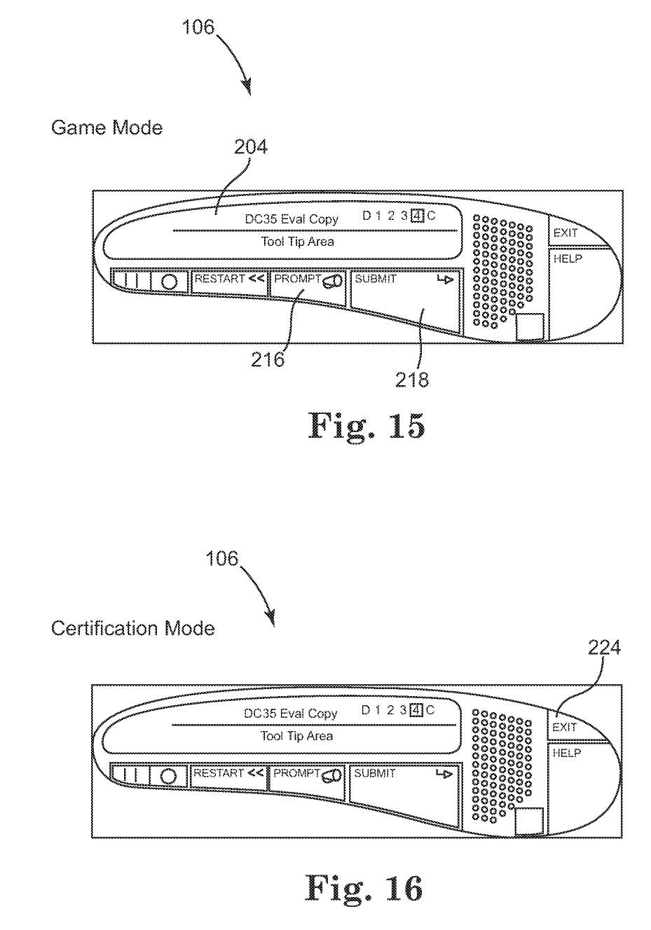

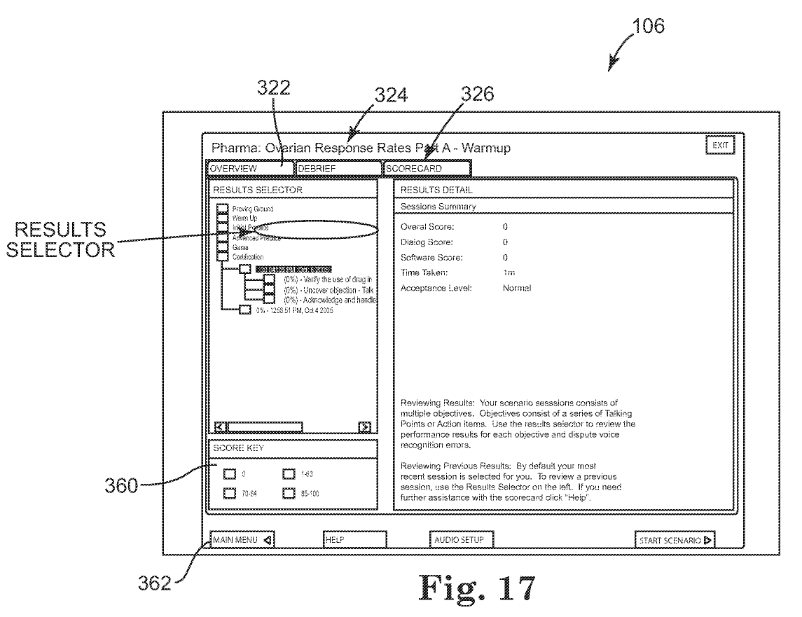

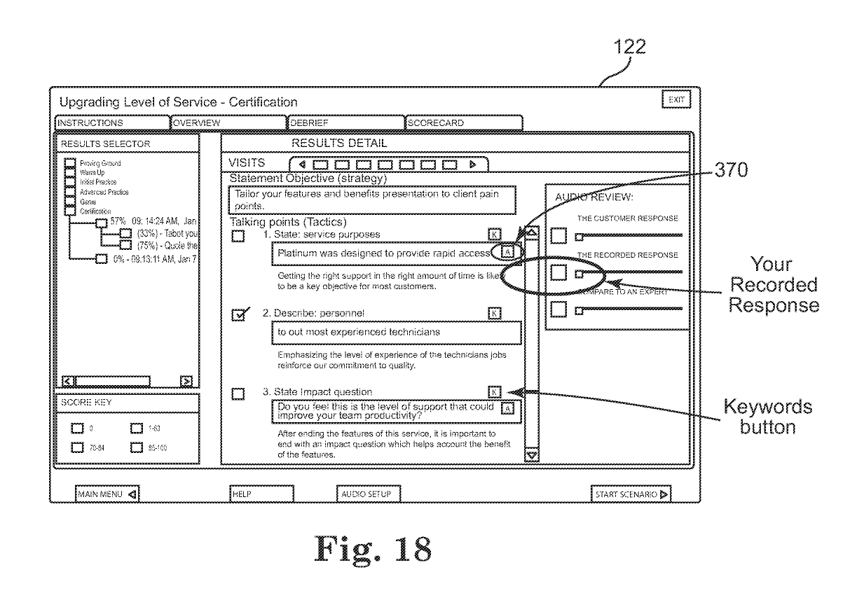

FIG. 16 illustrates player interface 106 operational in certification mode m5 according to one embodiment of the present invention. Certification mode m5 is a self-evaluation mode. Player interface 106 records the user's performance but does not provide audible chimes or other audible feedback that might disrupt a user in completing the certification mode m5. In other words, certification mode m5 provides no cues as to talking points or action items, and the user will need to perform the action items without such assistance, thus developing mastery of the targeted dialog stream. In one embodiment, player interface 106 is configured to provide response to the user after they click on exit button 224. Clicking on exit button 224 transfers the user to the debrief tab 324 within certification mode m5, as illustrated in FIG. 17 below.

FIG. 17 illustrates use of debrief tab 324 in certification mode m5. As noted above, certification mode m5 is a self-evaluation mode in which the user is requested to evaluate their performance and click on the score card tab 326. Clicking score card tab 326 initiates player interface 106 to play an audio recording of the user and compare it point-by-point to talking points that were intended to be covered. In one embodiment, then, the user evaluates their performance through the score card tab 326 in order to receive a finalized score.

In one embodiment, program 104 calculates a total score based upon the formula:

Total score=(100/(the sum of scenario items))×(the sum of correctly answered scenario items).

If the user requests a hint, program 104 reduces the total score by 10 percent. In one embodiment, a score key 360 is provided above a main menu button 362. In one embodiment, the score key is color coded to include white indicating a 0 percent performance level, red indicating a performance level from 1 to 69 percent, yellow indicating a performance from 70-84 percent, and green indicating a performance level from 85-100 percent.

FIG. 18 illustrates score card 360 showing a detailed display of all points earned during the user's performance, audio recordings of the user's performance, and score markers for each segment of each learning unit LU. Score card 360 provides access to all elements of the desired dialog including whys, dialog scripts, key words, example audio, and customer response audio. In this regard, when the user first opens score card 360, a summary of the user's performance from the most recent session is displayed. However, this is merely a voice recognition score, and not a total final score. In particular, an accept button 370 is provided that enables the user to override the score card 360 and provide credit for a talking point that the user's believes was conveyed in an appropriate manner. To this end, if the user believes that they have conveyed the information of a talking point correctly but has not received credit, clicking the accept button 370 provides credit to the user. Their score is updated automatically.

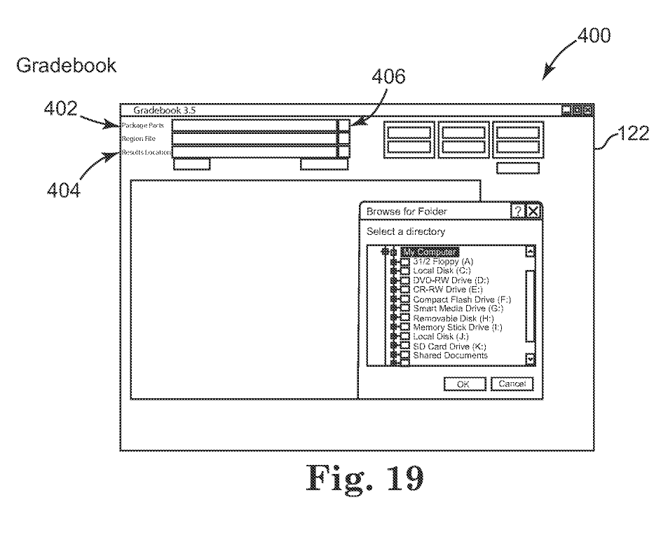

FIG. 19 illustrates a grade book 400 according to one embodiment of the present invention. Grade book 400 is displayed on screen 122 as a portion of player interface 106. In one embodiment, grade book 400 includes a packages path window 402 that communicates with computer 102 to bring up a browser folder option. A results location window 404 is provided that brings up a browser folder option. Navigating and selecting this folder reveals the results that a user has collected electronically via email after running program 104 on the Internet. Results can be loaded by clicking an upload button with mouse 112. Navigation buttons are provided in packages path window 402 and results location window 404 to enable the user to navigate within memory storage locations of the hard drive within computer 102.

Embodiments of the present invention provide a system that employs electronic voice recognition to track user performance in mastering a dialog stream or scenario. The system includes on-screen training procedures that interact directly with the user, and cues emulated and non-emulated actions on a viewing screen of a monitor of a player interface. These aspects of the system provide a reusable learning interaction to the user that mentors the user to master desired dialog streams.

The system includes mentoring shells, or modes m1-m5, that instructs and mentors the user in procedural tasks related to specific dialog activities. The mentoring process provided by the five separate modes provides more robust interactive software training than is currently available. The system provides for self-evaluation at the end of each learning unit. Extensive mentoring feedback loops provided across five levels or modes, combined with self-evaluation strategies at the end of each scenario, results in a new and useful comprehensive learning content management system.

The player interface of the system is fueled by data files that are created by the electronic program. The electronic program compiles various learning units that form building blocks for the user to customize their learning curriculum. As noted above, the editor program is flexible, and can create either an XML document, or an HTML document usable on the World Wide Web.

Embodiments of the present invention provide a player interface that has a floating toolbar menu that enables real time interaction by the user across the various modes of the program. In this regard, the system enables both audio and visual interaction of the user with the player interface.

The program provides intelligent feedback based upon what it hears the user speak into the microphone, and evaluates this audio stream through the voice recognition engine. The program interacts with the user by providing hints and other cues that mentor and instruct the user in becoming a master in the desired dialog stream.

The reusable learning interactions (RLI) provide electronic learning building blocks that the user can mix and match to build a variety of learning curriculums. This reusable learning interaction structure forms a program shell that enables each user to develop a user-specific and targeted curriculum.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A learning content mentoring system for use by a user to master a desired dialog, the system comprising:
a computer operable to run an editor program and generate a scenario file including a plurality of scenario segments of the desired dialog; and
a player interface in electrical communication with the scenario file;
wherein the editor program is operable to challenge the user with the scenario segments of the desired dialog, the player interface is operable to transmit a user response to the editor program for comparison with an expected response, and the editor program interacts with the player interface based on the user response to train the user to respond with the desired dialog.

2. The system of claim 1, wherein the player interface comprises a voice recognition engine.

3. The system of claim 2, wherein the voice recognition engine comprises a keyword voice recognition engine.

4. The system of claim 2, wherein the player interface comprises a pause button that is operable to stop voice recording of the voice recognition engine.

5. The system of claim 2, wherein the player interface comprises a listen button that is operable to selectively record audio for transmission to the editor program.

6. The system of claim 2, wherein the player interface comprises a restart button that is operable to repeat the challenge of the scenario segment of the desired dialog.

7. The system of claim 2, wherein the player interface comprises a prompt button that is operable to generate a hint related to the scenario segment of the desired dialog.

8. The system of claim 2, wherein the player interface comprises a submit button that is operable to register all user responses to the scenario segments of the desired dialog to the editor program for comparison with expected responses.

9. The system of claim 2, wherein the player interface comprises an act button that is operable to remind the user of a physical act that is to be completed concurrent with an audio response from the user.

10. The system of claim 2, wherein the player interface comprises a compare playback button that is operable to play an audio portion of the expected response.

11. A learning content mentoring system useful in mastering a stream of dialog, the system comprising:
computer operated means for generating a file including segments of an expected dialog;
electronic means for cuing a user response related to the expected dialog; and
means for electronically capturing the user response, comparing the user response to the expected dialog, and interacting with the user based upon the comparison between the user response and the expected dialog.

12. The system of claim 11, wherein the electronic means for cuing a user response comprises a video emulation of the expected dialog being spoken.

13. The system of claim 11, wherein the means for interacting with the user based upon the comparison between the user response and the expected dialog comprises a computer generated hint displayed on a monitor for the user to read.

14. A computer-readable medium having computer-executable instructions useful in mentoring a user to learn a desired dialog, the computer-readable medium comprising:
an editor program configured to generate a scenario file including a plurality of scenario segments; and
a player interface configured to electronically communicate with the scenario file;
wherein the user inputs data into the player interface in response to one of the plurality of scenario segments, and the editor program interacts with the player interface based on the input data to train the user to respond with the desired dialog.

15. The computer-readable medium of claim 14, wherein the editor program is configured to generate a performance record of user responses to the desired dialog.

16. The computer-readable medium of claim 14, wherein the editor program is operable in hyper text markup language.

17. The computer-readable medium of claim 14, wherein the editor program is configured to generate an extensible markup language scenario file.

18. The computer-readable medium of claim 14, wherein the plurality of scenario segments comprise keywords, and the player interface comprises a voice recognition engine configured to electronically communicate with the scenario file.

19. The computer-readable medium of claim 14, wherein the player interface comprises a computer monitor interface that electronically communicates with the scenario file via a mouse cursor.

20. The computer-readable medium of claim 19, wherein the computer monitor interface comprises an on-screen emulator configured to generate an image related to the desired dialog.

21. A mentoring system comprising:
a scene editor configured to compile scenario data to create a virtual role play mentor;
a voice recognition engine;
a multi-mode mentoring system having a plurality of modes, configured to use the scenario data and voice recognition engine, to operate the virtual role play mentor; and
a performance generator for generating a portfolio of a user's experience for one or more modes.

22. The system of claim 21, comprising:
wherein each mode is defined to include a level of system help, and where the level of system help is different for each mode.

23. The system of claim 21, comprising:
where the voice recognition engine is a keyword voice recognition engine.

24. The system of claim 21, comprising:
where the voice recognition engine is a detailed word recognition engine.

25. The system of claim 21, comprising:
wherein the portfolio includes generating a voice recognition user score for one or more modes.

26. The system of claim 21, comprising:
where the portfolio includes recording what a user said for a scenario in one or more modes.

27. The system of claim 21, comprising:
a first mode including a script based on the scenario data to be read by a user, wherein the voice recognition engine is responsive to the user.

28. The system of claim 27, comprising:
a second mode including playing a demo for a user.

29. The system of claim 28, comprising:
a third mode comprising a plurality of talking points, and where the virtual role play mentor utilizes the talking points, and wherein the performance generator determines a score based on a user's recollection of the talking points.

30. The system of claim 29, comprising:
a fourth mode having less system help than the third mode.

31. The system of claim 30, comprising:
a fifth mode having less system help than the fourth mode.
